(19) United States
(12) Patent Application Publication
(10) Pub. No.: US 2026/0070830 A1
(43) Pub. Date: Mar. 12, 2026

(54) SLURRY TREATMENT APPARATUS

(71) Applicant: VIETTI SLURRYTEC (PTY) LTD, Midrand (ZA)

(72) Inventor: Andrew Joseph Vietti, Midrand (ZA)

(21) Appl. No.: 19/107,297

(22) PCT Filed: Aug. 1, 2023
(86) PCT No.: PCT/ZA2023/050043

§ 371 Date: Feb. 27, 2025

(30) Foreign Application Priority Data
Aug. 30, 2022 (ZA) 2022/09637

(51) Int. Cl. C02F 11/123; B01D 33/04; B01D 33/056; B01D 33/76; B01D 37/03; C02F 11/147; C02F 103/10

(52) U.S. Cl. CPC C02F 11/123; B01D 33/04; B01D 33/056; B01D 33/763; B01D 37/03; C02F 11/147; C02F 2103/10

(57) ABSTRACT

An apparatus (110 or 10) for treating a flocculated slurry (18) with an initial liquid content comprising a treatment arrangement defining a treatment zone (114) in which the slurry (18) is supported on a treatment surface (16) of the treatment arrangement, a feed arrangement (116) for feeding slurry (18) into the apparatus (110 or 10), a discharge (118) through which output product (24) is discharged from the treatment zone (114), wherein the treatment surface (16) is configured such that interaction between the treatment surface (16) and the slurry (18) causes at least a portion of liquid within the slurry (18) to be separated therefrom, such that a liquid content of the output product (24) is lower than the initial liquid content.

### BACKGROUND TO THE INVENTION

This invention relates to a dewatering and/or densifying and/or compaction apparatus. More particularly, the present invention relates to an apparatus, a system and a method utilised in the process of primary dewatering and densifying of a flocculated slurry, such as a flocculated tailings stream, to produce a product for direct disposal, or for further, secondary processing, to create a high-density conveyable product for dry tailings disposal.

In-line flocculation is a recognised form of primary tailings dewatering, mainly used in the Oil Sands Industry for dewatering mature fine tailings (MFT) for final tailings disposal. Mature fine tailings at moderately high solids concentration (>25% m) comprises a slurry of a pumpable consistency and is pumped from existing tailings storage dams and flocculated in-line to achieve a “cottage cheese” type consistency.

The flocculated slurry is discharged end-of pipe into a designed tailings storage facility (TSF), where clear water is drained off and further densifying of the solids takes place by gravity consolidation only.

A thickener, on the other hand, is a primary dewatering device commonly used in the minerals processing and other industries. Three processes, namely, flocculation; solid/liquid separation and solids consolidation, take place in the same unit.

Flocculation typically occurs in a feed-well, after which, the flocculate solids separate from clear liquid, which reports to an overflow of the tank. The solids sediment to the base of the tank to form a “mud bed”, which is further dewatered and densified by gravity consolidation only, or by shear assisted gravity consolidation, where a picket rake is installed.

A low-density (or higher-density paste) thickened underflow is typically hydraulically transported to the TSF for disposal.

In the case of dry stacking disposal, the thickener underflow needs to be directed to a secondary dewatering device, which employs mechanical compaction of the underflow. The secondary dewatering device typically takes the form of a filter (in the form of a vacuum filter or pressure filter) or a centrifuge or press (in the form of a screw press or belt press) which employ purely mechanical compaction methods to generate very high-density tailings products suitable for conveyor transport.

Conventional primary dewatering apparatuses (thickeners and the less commonly used in-line flocculation), are high throughput, relatively low-cost methods for dewatering and densifying tailings. However, since they rely on gravity assisted consolidation processes only, they are not able to generate high density products. In contrast, secondary dewatering apparatuses can generate high density products by the use of mechanical compaction processes. This advantage is, however, off-set against high power and cost requirement and low tonnage throughput. A need therefore exists for a low-cost, low-power and high-throughput alternative primary dewatering, densifying and/or compaction apparatus, system, and method.

It is accordingly an object of the invention to provide an apparatus, system and method used in the primary dewatering, densifying and/or compaction of a flocculated slurry, that will, at least partially, address the above disadvantages.

It is also an object of the invention to provide an apparatus, system and method used in the primary dewatering, densifying and/or compaction of a flocculated slurry, which will be a useful alternative to existing apparatuses, systems, and methods.

### SUMMARY OF THE INVENTION

In accordance with a first aspect of the invention there is provided an apparatus for treating a flocculated slurry with an initial liquid content, the apparatus comprising:
a treatment arrangement defining a treatment zone in which the slurry is supported on a treatment surface of the treatment arrangement;
a feed arrangement for feeding slurry into the apparatus;
a discharge through which output product is discharged from the treatment zone,
   wherein the treatment surface is configured such that interaction between the treatment surface and the slurry causes at least a portion of liquid within the slurry to be separated therefrom, such that a liquid content of the output product is lower than the initial liquid content.

The interaction between the treatment arrangement and the slurry, which causes at least a portion of liquid within the slurry to be separated therefrom, includes displacement and/or motion of the treatment surface relative to the slurry.

The displacement and/or motion of the treatment arrangement relative to the slurry operatively causes a “kneading” or “massaging” action on the slurry, thereby gently mechanically squeezing liquid therefrom.

The treatment arrangement may be arranged to receive the slurry on top thereof, in use.

The apparatus may include a displacement mechanism for operatively displacing the treatment arrangement relative to the slurry.

The treatment arrangement may be manufactured from a material having a friction coefficient which facilitates or aids separation of the liquid from the slurry.

The treatment arrangement may be porous or foraminous and may allow the portion of liquid to drain therethrough under gravity.

The apparatus may further comprise a collection receptacle to collect liquid separated from the slurry. The collection receptacle may be arranged below the treatment arrangement.

The apparatus may furthermore comprise a conveyor arrangement for transporting the product discharged from the treatment arrangement through the discharge.

The treatment arrangement may be formed by a flexible sheet. The flexible sheet may be supported by at least a first roller, which forms part of the displacement mechanism. The flexible sheet may be suspended from the at least first roller.

The flexible sheet may be formed into a sleeve, which may be arranged around the at least first roller and be supported thereby, by being suspended therefrom. The treatment zone may be formed by a first trough-shaped portion of the sleeve.

The displacement mechanism may include a second roller. The sleeve may be arranged around the second roller and may be supported thereby, by being suspended therefrom.

The first and second rollers may be arranged substantially parallel to each other.

The displacement mechanism may include a drive unit. The drive unit may comprise a motor, such as an electric, hydraulic, or pneumatic motor, and a transmission arrangement.

The transmission arrangement may constitute one of a belt and pulley arrangement, and a sprocket and chain arrangement. Alternatively, the drive unit and transmission arrangement may be integral, in the form of a motor-gear arrangement.

The displacement mechanism may furthermore comprise a drive roller, driven by the drive unit. The drive roller may be arranged between the first and second rollers.

The apparatus may include a bottom roller supporting a bottom portion of the sleeve, such that first and second trough-shaped portions are formed towards opposite sides of the bottom roller, the first trough shaped-portion defining the treatment zone, and the second trough-shaped portion defining a feed zone. In use, slurry may be deposited onto the treatment arrangement, or sleeve, in the feed zone, from where the slurry may be carried by the treatment arrangement, or sleeve, over the bottom roller towards the treatment zone.

Each of the first and second trough-shaped portions may be associated with tensioning arrangements to retain a shape of the trough-shaped portions and to keep the treatment apparatus taut in use. The tensioning arrangements may comprise contact shoes running on outer edges of the treatment arrangement.

The feed arrangement may be arranged within the second trough-shaped portion or feed zone.

The feed arrangement may comprise:
a distribution header, comprising a plurality of outlets spaced along a width of the treatment arrangement; and/or
a feed container into which the plurality of outlets feed the slurry, and which is open at a top end to define an overflow, to allow slurry to spill over and onto the treatment arrangement; and/or
a feed pan within which the feed container is arranged.

Each outlet of the distribution header may be associated with an outlet duct.

The feed container may comprise a plurality of spaced compartments, each compartment associated with, and fed by, a distinct outlet of the distribution header.

The distribution header may be arranged above the feed container.

The arrangement may be such that the outlet ducts feed slurry to a bottom of the respective compartments, such that slurry within the respective compartment may rise from the bottom towards the overflow in a gentle and controlled manner, at a controlled or predetermined rise rate.

The feed pan may comprise an overflow which overflows into the collection receptacle. The feed pan may contain water. A level of the overflow may be selected based on whether the slurry is fed into the feed container sub-aqueously or sub-aerially. In one example, the overflow of the feed container may be lower than the overflow of the feed pan, operatively to submerge the feed container below a level of the water in the feed pan, and to facilitate feeding the slurry to the feed pan sub-aqueously. In another example, the overflow of the feed container may be higher than the overflow of the feed pan, operatively to facilitate feeding the slurry to the feed pan sub-aerially.

The configuration of the feed arrangement (including a rate at which same is driven, material from which same is manufactured (and therefore a friction coefficient), an angle of the feed arrangement proximate the spill over of the feed container, and the like) is such that slurry is carried by the feed arrangement over the bottom roller and towards the treatment zone.

The treatment arrangement or sleeve may be associated with a tracking arrangement. At least one of the first and second rollers may comprise radially extending teeth, cogs or pegs provided in mesh with suitable openings or slots formed on the sleeve. The openings or slots may take the form of slots cut into the sleeve, or rings or eyelets sequentially formed about a perimeter of the sleeve. Alternatively, a reinforced strip provided with slots may be affixed to the sleeve. The reinforced strip may be manufactured from a polymeric material, such as polyurethane.

The teeth, cogs or pegs may be formed towards either side of the roller. Both rollers may be provided with teeth, cogs, or pegs.

The teeth, cogs, or pegs may be used to drive the sleeve, and/or to retain the portion of the sleeve extending at the top end between the first and second rollers substantially taut, and/or to retain a shape or length of the free-hanging portion substantially constant, in use.

A scraper may be provided in contact with the treatment arrangement or sleeve, outside of and after the treatment zone, to aid removal of any material which may adhere to the treatment arrangement or sleeve.

The apparatus may include a spray bar provided for rinsing an outer surface of the sleeve. Water used in the process of rinsing the sleeve may be captured by the collection receptacle.

The collection receptacle may drain into a return conduit.

The apparatus may include a material displacement arrangement mounted in or proximate the treatment zone, to displace output product from the treatment zone and inhibit a build-up of material within the treatment zone.

The material displacement arrangement may comprise a plough arrangement with which output product may be urged towards one or both sides of the treatment zone, to be deposited from the treatment zone.

The plough arrangement may comprise a central blade, and at least a first disc plough towards a side thereof.

Displacement of the output product by means of the plough arrangement may result in a folding action of the output product, which may result in a further dewatering of the output product.

In an alternative embodiment according to the first aspect of the invention, the treatment arrangement comprises a first trough-shaped portion only.

The apparatus according to the alternative embodiment may furthermore comprise a charge opening for depositing slurry onto the treatment arrangement, from where the slurry travels in a travel/feed direction.

In some cases, the displacement of the treatment surface may constitute vibration or agitation of the surface. The treatment surface may be substantially flat, or trough shaped.

In cases where the treatment arrangement comprises a flexible sheet, the at least first roller may extend substantially in the travel direction.

Alternatively, the first and second rollers may converge in the travel/feed direction.

The rollers may be arranged substantially horizontally. Alternatively, the rollers may be inclined upwards (in the displacement direction) such that the charge opening is lower than the discharge. Further alternatively, the rollers may be inclined downwards (in the displacement direction) such that the charge opening is higher than the discharge, to provide for gravity-assisted displacement of the slurry relative to the treatment surface.

The apparatus may comprise a main structure. The first and second rolls may be mounted to a subframe, which in turn, may pivotably be mounted to the main structure.

A rocking device may be provided for causing a rocking motion of the subframe. The rocking device may comprise a rocking motor, driving a crank or rocking transmission device.

The rocking device may, in use, cause further displacement of the treatment surface.

The drive unit and transmission arrangement of the displacement mechanism may also be mounted to the subframe.

The displacement of the treatment surface may cause the slurry to be displaced in the travel direction.

The first and second rollers may, in use, be driven in the same or opposing rotational directions. The first and second rollers may be mechanically linked together.

A portion of the sleeve extending at a top end between the first and second rollers may be kept substantially taut.

The drive unit may, in use, drive the roller(s) by causing the roller(s) to rotate or oscillate.

In some cases, the rollers may have a coarse pitch spiraling outer surface, provided to create folds in the sleeve, which folds may induce a positive conveyor motion or peristaltic motion to displace the slurry in the travel direction.

The drive roller may be one or both of the first and second rollers.

In some examples, a slurry drive mechanism may be provided for displacing the slurry in the travel direction. The slurry drive mechanism may comprise a first course pitch auger which may be rotated to drive the slurry in the travel direction. The slurry drive mechanism may also include a second course pitch auger.

In accordance with a second aspect of the invention there is provided a system for treating a slurry, the system comprising:
a feed of slurry;
a flocculant dosing and flocculating device; and
an apparatus in accordance with the first aspect of the invention, wherein the flocculant dosing and flocculating device receives the feed of slurry, flocculates the slurry by dosing the slurry and allowing flocs to be generated, and provides the flocculated slurry via a feed arrangement of the apparatus to a treatment arrangement of the apparatus.

The flocculant dosing and flocculating device may comprise an in-line flocculant dosing and flocculating device. The flocculant dosing and flocculating device may utilise a high molecular weight polyethylene oxide (POE) flocculating reagent or a polyacrylamide reagent to flocculate the slurry.

In accordance with a third aspect of the invention, there is provided a method of treating a flocculated slurry with an initial liquid content, the method comprising the steps of:
1. providing an apparatus in accordance with the first aspect of the invention;
2. feeding the slurry through a feed arrangement onto a treatment arrangement of the apparatus;
3. causing the slurry to be displaced relative to the treatment arrangement;
4. separating at least a portion of liquid from the slurry as it is displaced relative to the treatment arrangement; and
5. discharging an output product through a discharge of the apparatus, which output product has a liquid content which is lower than the initial liquid content.

The step 2 above may be preceded by the following steps:
2a. receiving a feed of slurry from a supply;
2b) utilising a flocculant dosing and flocculating device to flocculate the slurry; and
2c) feeding the flocculated slurry to the charge opening.

The step 2b) may comprise adding a high molecular weight polyethylene oxide (POE) flocculating reagent to the slurry to flocculate the slurry.

Step 4 above may comprise displacing the treatment arrangement relative to the slurry to cause the water to separate from the slurry, and to cause floc aggregates to become dewatered, densified and compacted. The displacement of the treatment arrangement may cause the floc aggregates to roll over itself and become kneaded mechanically under the influence of gravity.

### BRIEF DESCRIPTION OF THE DRAWINGS

The invention will now be described in more detail, by way of example only, with reference to the accompanying drawings in which:

FIG. 1 shows a side perspective view of an apparatus used in the treatment of a slurry, in accordance with the invention;

FIG. 2 shows a sectioned side view of the apparatus of FIG. 1;

FIG. 3 shows a detailed side view of a scraper arrangement forming part of the apparatus of FIG. 1;

FIG. 4 shows a detailed view of a second trough-shaped portion, or feed portion, of a treatment arrangement, associated with a feed arrangement, of the apparatus of FIG. 1;

FIG. 5 shows a front view of the apparatus of FIG. 1;

FIG. 6 shows a perspective view of the feed arrangement of the apparatus of FIG. 1;

FIG. 7 shows a side view of a first trough-shaped portion, or treatment zone, including a material displacement arrangement, of the apparatus of FIG. 1;

FIG. 8 shows a detailed rear view showing details of the material displacement arrangement of FIG. 7;

FIG. 9 shows a side perspective view of an alternative example embodiment of an apparatus used in the treatment of a slurry, in accordance with the invention;

FIG. 10 shows a detailed perspective view of a displacement mechanism of the apparatus of FIG. 9;

FIG. 11 shows a front view of the apparatus of FIG. 9;

FIG. 12 shows a top view of the apparatus of FIG. 9;

FIG. 13 shows a schematic side view of the apparatus of FIG. 9;

FIG. 14 shows a schematic side view of an alternative example embodiment of the apparatus of FIG. 9;

FIG. 15 shows a schematic side view of yet a further alternative example embodiment of the apparatus of FIG. 9.

### DESCRIPTION OF THE ILLUSTRATED EMBODIMENTS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted”, “connected”, “engaged” and variations thereof are used broadly and encompass both direct and indirect mountings, connections, supports, and couplings and are thus intended to include direct connections between two members without any other members interposed therebetween and indirect connections between members in which one or more other members are interposed therebetween. Further, “connected” and “engaged” are not restricted to physical or mechanical connections or couplings. Additionally, the words “lower”, “upper”, “upward”, “down” and “downward” designate directions in the drawings to which reference is made. The terminology includes the words specifically mentioned above, derivatives thereof, and words or similar import. It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

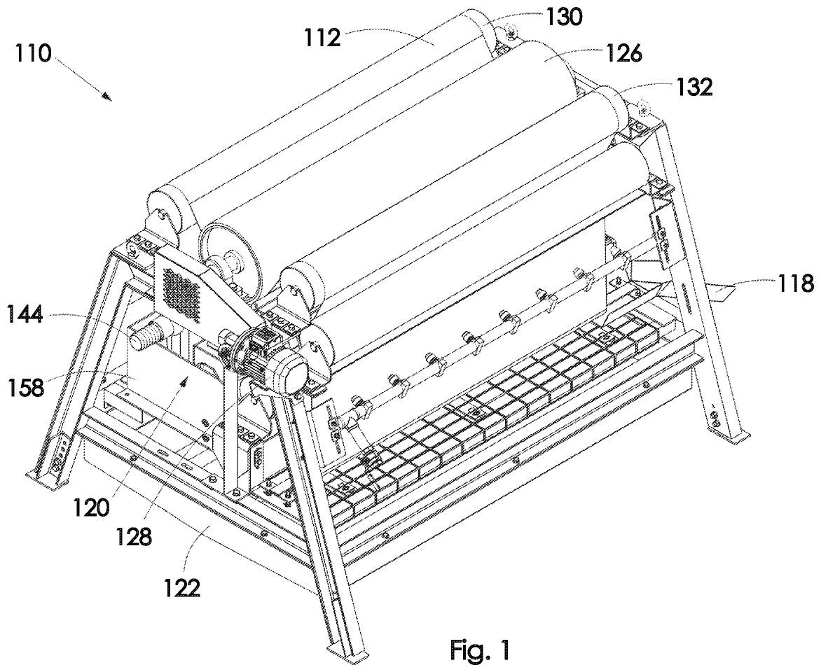

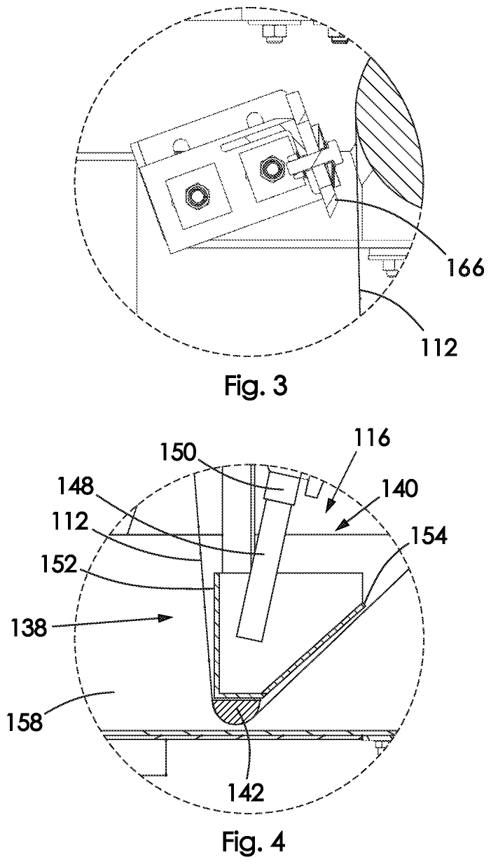

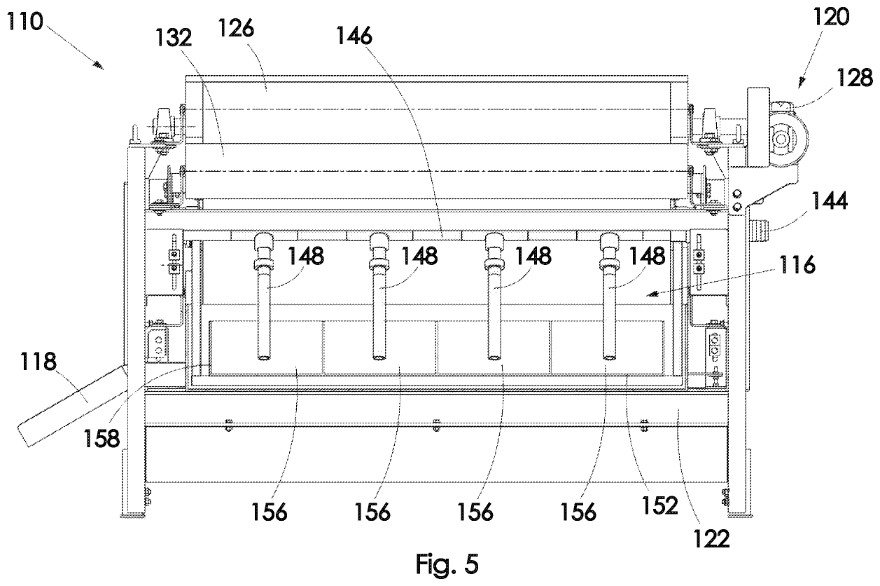

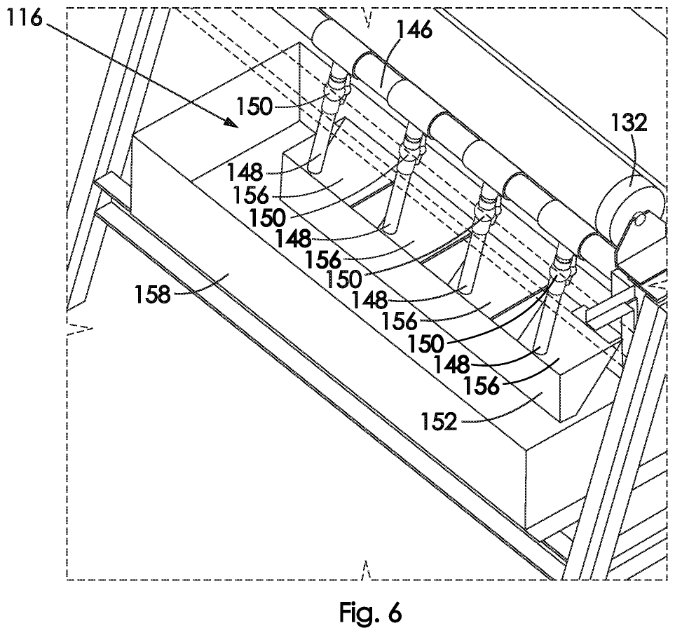

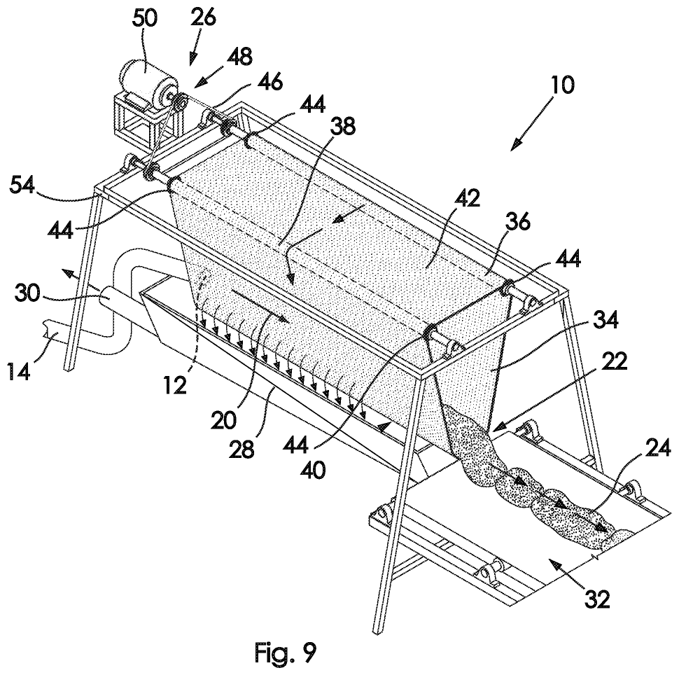

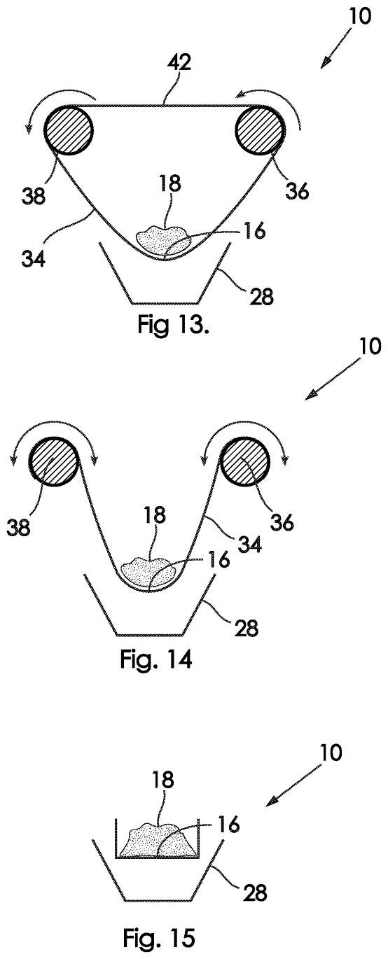

In the figures, like numerals indicate like features. Referring to FIGS. 1 to 8, a first non-limiting example of an apparatus used in the treatment of a slurry, in accordance with the invention, is generally indicated by reference numeral 110. FIGS. 9 to 15 show a second non-limiting example of an apparatus used in the treatment of a slurry, in accordance with the invention, which second example apparatus is generally indicated by reference numeral 10. Both apparatuses 110 and 10 are utilised in the primary dewatering, densifying and/or compaction of a slurry, which slurry is generally indicated by reference numeral 18. The slurry is conveyed from a storage facility such as a tailings dam or metallurgical processing plant (not shown) or a pre-processing device (such as a flocculant dosing and flocculating device which is not shown).

The slurry 18 has an initial liquid content (before being dewatered, densified and/or compacted by the apparatus 110 or 10), and may typically, have undergone some pre-treatment before being fed to the apparatus 110 or 10. Typically, the slurry 18 is a flocculated slurry. More is said about this below.

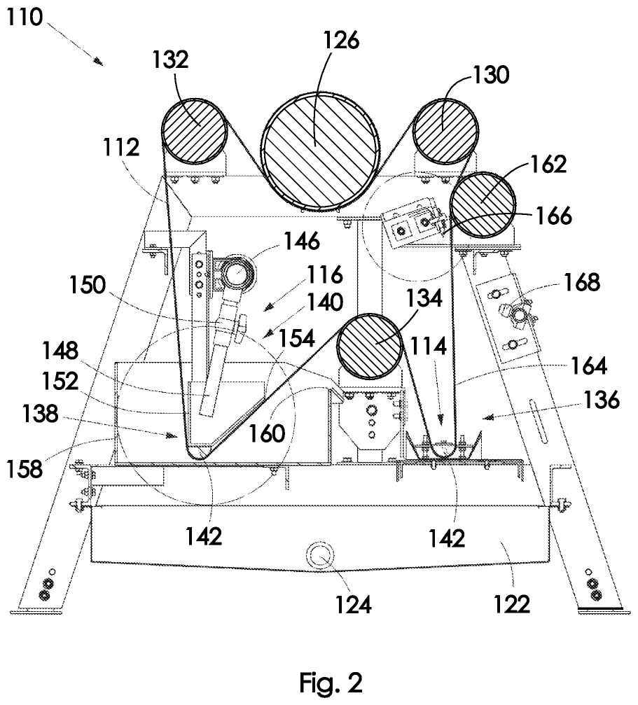

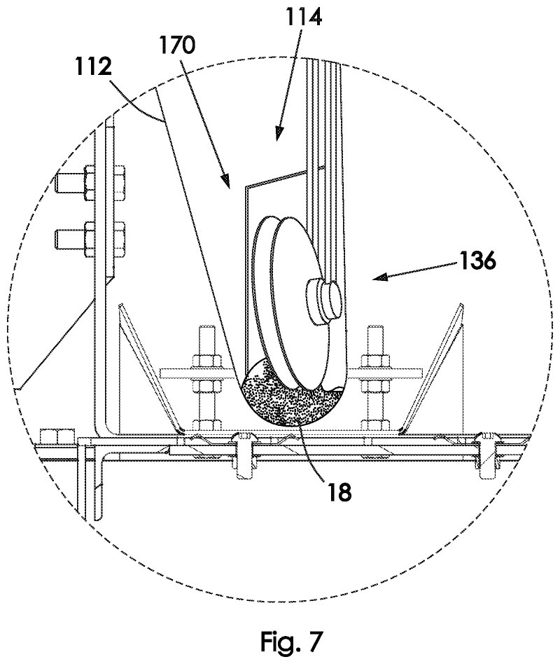

Reference is now made specifically to FIGS. 1 to 8. The apparatus 110 comprises a treatment arrangement, which in this example embodiment, takes the form of a sheet 112 of a flexible material, formed into an endless sleeve. The treatment arrangement, sheet and sleeve will all be referred to with reference to numeral 112 throughout this disclosure. The treatment arrangement 112 defines a treatment zone 114 (best shown in FIGS. 2 and 7) in which the slurry 18 is supported on top of the treatment arrangement, or sheet 112.

The apparatus 110 also includes a feed arrangement 116 for feeding slurry 18 to the apparatus 110, and more particularly, onto the treatment arrangement 112. Once fed onto the treatment arrangement 112, interaction between the treatment arrangement or sheet 112 and the slurry 18 causes at least a portion (or a substantial portion) of liquid within the slurry to be separated therefrom to result in an output product having a liquid content which is lower than the initial liquid content. The sheet 112 is specifically selected with such interaction in mind.

The interaction between the sheet 112 and the slurry 18, as mentioned above, and the treatment effected thereby, is firstly influenced, or facilitated by the type of material and construction of the sheet 112, and secondly, by operative displacement of the treatment arrangement relative to the slurry 18.

The interaction between the treatment arrangement 112 and the slurry 18, which causes at least a portion of liquid within the slurry 18 to be separated therefrom, typically results from displacement and/or motion of the treatment arrangement 112 relative to the slurry 18, which may cause the slurry 18 to roll or be folded over itself, gently. The displacement and/or motion of the treatment arrangement 112 relative to the slurry 18 operatively causes a mechanical “kneading” or “massaging” action on the slurry 18, thereby gently squeezing liquid therefrom. This action is gentle, so as not to cause the output product to break apart or disintegrate.

For this purpose, the sheet 112 is manufactured from a material which is porous or foraminous, to allow liquid to drain therethrough under gravity. Furthermore, the material from which the sheet 112 is manufactured has a predetermined friction coefficient, which facilitates the interaction between it and the slurry 18 and therefore, facilitates the separation of the portion of the liquid therefrom.

The sheet typically has a friction coefficient which is selected with interaction between it and the slurry in mind. Typically, a higher friction coefficient facilitates compaction of the slurry, separation of the portion of the liquid from the slurry, and the consolidation of individual flocs, particles, lumps, or masses. Furthermore, the friction and relative displacement causes these individual flocs to roll over itself, thereby facilitating compaction and further dewatering thereof. It will be appreciated that upon entry onto treatment arrangement the flocs are relatively fragile, and therefore, the amount and vigour of the relative displacement, and the aggressiveness of the friction coefficient of the surface, is preselected and configured to prevent the flocs breaking apart. The process is therefore gentle and can be likened with a kneading or massaging action administered to the flocs. The process is therefore a low-pressure process, and distinct from a process where mechanical pressure or compression is applied to a slurry. The flocs are therefore relatively loosely received on the treatment arrangement 112.

The output product is discharged from the apparatus 110 via a discharge 118. In the figures, the discharge is schematically shown towards one side of the apparatus 110. However, in practice, the apparatus may typically comprise a second discharge 118 towards a second or opposite side of the apparatus 110, such that output product may be discharged from either side of the treatment zone 114.

It will be appreciated that the apparatus 110 converts a pumped slurry into an output product which may be stable enough, with high enough internal strength, and dry enough, to be transportable by means of a conveyor arrangement. The conveyor arrangement transports the output product to a downstream processing facility (not shown), where further, secondary dewatering processing may be conducted. Alternatively, the output product may be directly disposed, and the conveyor arrangement may transport the output product to a disposal facility or a transport vehicle.

The apparatus 110 comprises a displacement mechanism or arrangement 120 which is provided for displacing the treatment arrangement relative to the slurry 18. The displacement mechanism 120 comprises various components, and will collective and generally, be referred to by reference numeral 120. The displacement mechanism 120, for example, includes rollers and the like, which support the sleeve 112 in use, and a drive mechanism which drives the rollers. More is said about this below.

Towards a bottom of the apparatus 110, and particularly, at least directly below the treatment zone 114, there is a collection receptacle 122 with a drain 124. The collection receptacle 122 catches or collects liquid separated from the slurry, and liquid spill-over associated with the feed arrangement 116, as discussed more fully below. Liquids are drained from the collection receptacle 122 through the drain 124, and may be discarded, recycled or recirculated in known fashion.

The displacement mechanism 120 comprises a main drive roller 126, which is arranged towards a central top portion of the apparatus 110, and which is driven by a motor-gear unit 128. The motor of the motor-gear unit 128 may typically be an electric motor, though the use of other motors, such as pneumatic, hydraulic or internal combustion motors may also be feasible. The gear unit of the motor-gear unit 128 may comprise any suitable transfer arrangement, such as a unit comprising gears in mesh, a sprocket and chain assembly, a belt and pulley assembly and the like. The drive roller 126 is covered with a gripping material, such as a natural or synthetic rubber, to enable same to grip to the sleeve 112 and cause same to be displaced.

The displacement mechanism 120 also includes further support rollers, such as a first roller 130 and a second roller 132, arranged towards opposite sides of the drive roller 126, and both of which are provided for supporting the sleeve 112. The sleeve 112 is suspended from the first and second rollers (130, 132), and therefore, runs over the first and second rollers (130, 132). The first and second rollers (130, 132) are arranged substantially parallel to one another.

The drive mechanism 120 includes a bottom roller 134 which is located physically below the drive, first and second rollers (126, 130, 132). The sleeve 112 runs over the bottom roller 134, such that a first trough-shaped portion 136 (of the sleeve 112) is formed towards a first side of the bottom roller 134, and a second trough-shaped portion 138 (of the sleeve 112) is formed towards a second side of the bottom roller 134. The treatment zone 114 is associated with the first trough-shaped portion 136, while the feed arrangement 116 is associated with the second trough-shaped portion 138, such that a feed zone 140 is defined within the second trough-shaped portion 138. This is discussed more fully below.

The first and second trough-shaped portions (136, 138) are associated with respective tensioning arrangements, which provide tension to bottom portions of the sleeve 112, and which aid in retaining the shapes of the trough-shaped portions (136, 138). The tensioning arrangements take the form of contact shoes 142 running on outer surface portions of the sleeve, in bottom portions of the respective trough-shaped portions (136, 138).

The sleeve 112 may, in some cases, be associated with a tracking arrangement (not shown), which ensures proper alignment and tracking of the sleeve, in use. Tracking arrangements of the known kind may be used. In some cases, at least one of the first and second rollers (130, 132) may comprise radially extending teeth, cogs or pegs provided in mesh with suitable openings or slots formed on the sleeve 112. The openings or slots may take the form of slots cut into the sleeve, rings or eyelets sequentially formed about a perimeter of the sleeve. Alternatively, a reinforced strip provided with slots may be affixed to the sleeve. The reinforced strip may be manufactured from a polymeric material, such as polyurethane.

The teeth, cogs or pegs may be formed towards either side of the first and/or second roller (130, 132).

In use, slurry 18 is deposited by means of the feed arrangement 116 (as discussed below) in the feed zone 140 and onto the sleeve 112, from where, it is carried over the bottom roller 134 and fed to the treatment zone 114. An angle of the sleeve 112 proximate the feed zone 140 (which angle is determined by a position of the bottom roller 134 and a spacing of the bottom roller 134 from the contact shoe 142 associated with the second trough-shaped portion 138) is small enough to ensure that the slurry can be carried over the bottom roller 134. This angle is therefore also determined by friction between the sleeve 112 and the slurry 18. While the slurry is carried towards the bottom roller 134, a small amount of liquid may already drip through the sleeve and thus be separated from the slurry 18.

The feed arrangement 116 comprises a main feed inlet 144 with which slurry 18 is provided to the apparatus 110, via a distribution header 146. The distribution header 146 is associated with a number of outlets, each provided with an outlet conduit 148. Each outlet conduit 148 may furthermore be associated with an individual shut-off valve 150. The outlets and outlet conduits 148 are spaced along a width of the apparatus 110, or at least a width of the feed zone 140 or the sleeve 112.

The feed arrangement 116 furthermore comprises a feed container 152. The feed container extends along a width towards a bottom portion of the second trough-shaped portion 138. The outlet conduits 148 feed slurry 18 into the feed container 152, and more particularly, into the bottom of the feed container. The distribution header 146 extends above the feed container 152 and therefore, the outlet conduits 148 extend downward towards the feed container 152. A top portion of the feed container 152 is open, and an overflow 154 is defined towards an upper front side thereof. Therefore, as slurry 18 is fed into the feed container 152, slurry gently spills over the overflow 154 and onto the sleeve 112, from where the sleeve 112 carries the slurry towards the treatment zone 114 as discussed before.

The feed container 152 comprises a number of compartments 156, each associated with a distinct outlet conduit 148. The separate compartments 156 aid and facilitate a better distribution of slurry over the width of the sleeve 112.

Since the slurry is fed to the bottom of the compartments 156, a “rise rate” or flow rate of slurry within the compartments may be controlled. In this way, the flow of slurry 18 may be controlled, and the slurry 18 may be fed gently and in a controlled manner, so as not to cause the slurry to disintegrate.

The feed arrangement 116 furthermore comprises a feed pan 158, within which the feed container 152 is arranged. The feed pan 158 also comprises an overflow 160. The feed pan 158 is filled with water, in use. Water and/or other liquids within the feed pan 158 spills over the overflow 160 into the collection receptacle 122.

A level of the overflow 154 relative to a level of the overflow 160 is important. In one example, the slurry 18 is fed to the feed container 152 sub-aerially. In such a case, the overflow 160 is at a lower level than the overflow 154. In another example, the slurry 18 is fed to the feed container 152 sub-aqueously, in which case the level of the overflow 160 is higher than the level of the overflow 154, such that the feed container 152 is submerged in the water contained in the feed pan 158. In the latter example, the sub-aqueous feeding of slurry 18 to the feed container 152 again assists in ensuring that the slurry 18 is fed gently to the apparatus 110.

The apparatus may furthermore comprise a tensioning roller 162 which causes tension in the sleeve 112, between the contact shoe 142 associated with the first trough-shaped portion 136 and first roller 130. The tensioning roller 162 also determines a return angle of the sheet 112, which is an angle of the sheet 112 directly following the treatment zone 114 (a return portion 164 of the sleeve). This angle is steep, so as to inhibit material from being carried by the sleeve 112 from the treatment zone 114. The return angle may be such that the return portion 164 extends substantially vertically. Material within the treatment zone 114 therefore generally rolls, folds and spills over itself rather than being carried out of the treatment zone 114 by the return portion 164 of the sheet.

That said, a scraper arrangement 166 may still be provided to remove any material that may adhere to the sleeve 112 and that may have been carried with the return portion 164 from the treatment zone 114.

Furthermore, the apparatus 110 may include a spray bar 168 which may direct a spray of water to a rear or bottom surface of the sleeve 112, to assist in removing any further material adhering to the sleeve 112, by rinsing the sleeve 112. Again, water used in this process is captured in the collection receptacle.

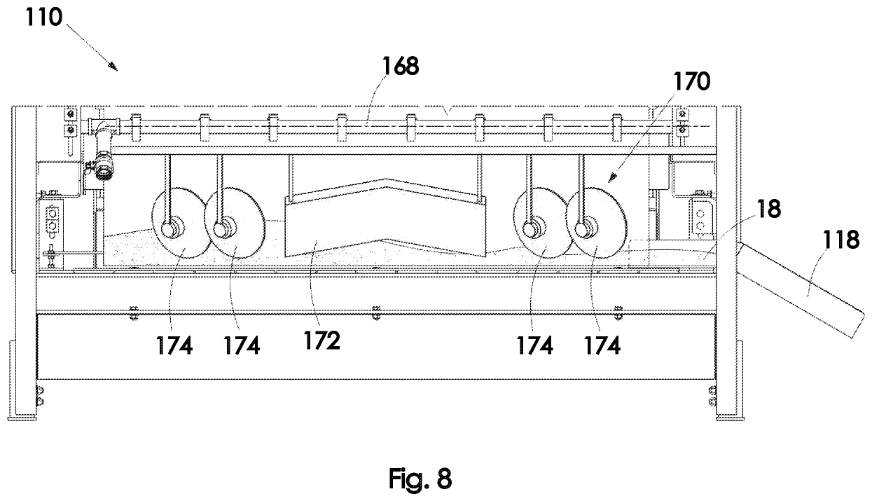

The apparatus 110 may furthermore include a material displacement arrangement 170 mounted in or proximate the treatment zone 114, with which material accumulating in the treatment zone 114 may be removed or displaced away from the treatment zone 114. As best shown in FIG. 8, the material displacement arrangement 170 may include a main, centrally mounted, blade 172 and a number of disc ploughs or blades 174. The main blade 172 and disc ploughs 174 may therefore urge material building up in the treatment zone 114 towards the discharge 118. This urging of material causes the material to be further folded over itself, gently, which may result in removing a further portion of liquid from the material. Alternatively, a dynamic material displacement arrangement (not shown) may be provided, which may take the form of a coarse pitch auger or the like, which may be driven from one of the rollers. The auger may urge the material towards the discharge, and may again, cause the material to roll or fold over itself. The auger will again be configured to cause a gentle displacement of the material so as not to cause same to become disintegrated.

It will be appreciated that the output product received from the apparatus 110 through the discharge 118, is, at least to a degree, dewatered, and therefore denser, more compact and more solid. This output product is therefore suitable for downstream secondary processing or direct disposal, as the need may arise.

### Original Version

Reference is now made to FIGS. 9 to 15. The apparatus 10 comprises a charge opening 12, through which the slurry 18 is fed or charged into the apparatus 10. The charge opening 12 may be formed at the end of a feedpipe 14 which conveys the slurry from a storage facility such as a tailings dam or metallurgical processing plant (not shown) or a pre-processing device (such as a flocculant dosing and flocculating device which is not shown).

The apparatus also includes a treatment arrangement, in the form of a surface 16 which is again associated with a treatment zone. The treatment surface 16 may take various forms, as discussed further below.

Generally, the treatment surface 16 supports the slurry 18 (on top thereof), which travels or is displaced along the treatment surface 16, in a travel, discharge or feed direction 20. The apparatus further includes a discharge 22, which may typically be formed at the end of the treatment surface 16, and through which output product 24 is discharged from the apparatus 10 or more specifically, the treatment surface 16. It will be appreciated that the output product comprises a dewatered, densified, and/or compacted form of the slurry. Therefore, typically, a liquid content of the output product 24 is lower than the liquid content of the slurry 18.

Furthermore, the treatment surface 16 is configured such that interaction between the slurry 18 and the treatment surface 16 causes the dewatering, densification and/or compaction of the slurry 18 to produce the output product 24. Therefore, due to the interaction with the treatment surface 16, at least a portion of the liquid within the slurry 18 is separated therefrom. This is discussed more fully below.

The interaction between the treatment surface 16 and the slurry 18, as mentioned above, and the treatment effected thereby, is firstly influenced, or facilitated by the type of material and construction of the treatment surface 16, and secondly, by operative displacement of the treatment surface 16 relative to the travel or feed direction 20, and therefore, relative to the slurry 18.

The treatment surface 16 typically has a friction coefficient which is selected with interaction between it and the slurry in mind. Typically, a higher friction coefficient facilitates compaction of the slurry, separation of the portion of the liquid from the slurry, and the consolidation of individual flocs, particles, lumps, or masses. Furthermore, the friction and relative displacement causes these individual flocs to roll over itself, thereby facilitating compaction and further dewatering thereof. It will be appreciated that upon entry onto treatment surface 16 the flocs are relatively fragile, and therefore, the amount and vigour of the relative displacement, and the aggressiveness of the friction coefficient of the surface, is preselected and configured to prevent the flocs breaking apart. The process is therefore gentle and can be likened with a kneading or massaging action administered to the flocs. The process is therefore a low-pressure process, and distinct from a process where mechanical pressure or compression is applied to a slurry. The flocs are therefore relatively loosely received on the treatment surface 16.

The treatment surface 16 is porous or foraminous and allows the portion of the liquid separated from the slurry as mentioned before, to drain therethrough under gravity. The aperture size of the porous or foraminous treatment surface 16 is selected based on the type of slurry. Typically, the aperture size is selected to allow the liquid to pass through easily (and therefore, large enough for surface tension of the liquid to be overcome) but not so large as to allow the flocs to pass therethrough.

In some embodiments, the treatment surface 16 may be manufactured from a substantially rigid material. The treatment surface 16 may be substantially flat, or trough shaped. In other embodiments, as shown in FIGS. 1 to 6, the treatment surface may be formed by a flexible sheet of woven fabric. This is discussed more fully below.

A collection receptacle or pan 28 is arranged below the treatment surface and provided to collect the liquid separated from the slurry 18. The liquid collected in the collection receptacle or pan 28 is returned via a return conduit 30 to a processing plant or storage facility for future use or disposal.

A conveyor arrangement 32 is provided for transporting the output product 24 discharged from the treatment surface 16 through the discharge 22. It will be appreciated that the apparatus 10 converts a pumped slurry into an output product 24 which is stable enough, with high enough internal strength, and dry enough, to be transportable by means of a conveyor arrangement 32. The conveyor arrangement 32 transports the output product to a downstream processing facility (not shown), where further, secondary processing may be conducted. Alternatively, the output product may be directly disposed, and the conveyor arrangement 32 may transport the output product to a disposal facility or a transport vehicle.

The apparatus 10 is provided with a displacement mechanism 26, which causes or induces the operative displacement of the treatment surface 16. The displacement may take the form of vibrations, oscillations, or agitation of the treatment surface 16.

As mentioned, in the embodiment shown in FIGS. 1 to 6, the treatment surface 16 is formed by a flexible sheet 34, in particular, formed into a sleeve. Two end portions of the sheet 34 are joined together by means of a clipper joint to form an endless sleeve. The sleeve is suspended over, and hangs from, a first and a second roller (36, 38), which rollers (36, 38) form part of the displacement mechanism 26. The first and a second roller (36, 38) extend substantially along the travel or feed direction 20, are arranged parallel to each other, and are spaced above the treatment surface 16.

The sleeve defines a free-hanging and trough-shaped bottom portion 40. The treatment surface 16 is formed on an inside of the free-hanging bottom portion 40. In use, slurry 18 weighs the bottom portion down. A portion 42 of the sleeve extending between the two rollers (36, 38) is kept substantially taut. The two rollers (36, 38) are arranged in positive mechanical communication, such as by being interconnected by means of a chain or belt 46, which forms part of a transmission 48 of the displacement mechanism 26. The rollers (36, 38) therefore rotate together.

The rollers are formed with sets of radially extending teeth, cogs, or pegs (the locations of which are indicated by reference numeral 44) which are provided in mesh with openings or slots (not shown) formed about a perimeter of the sleeve. The openings or slots may be cut into the sleeves, may be formed by rings or eyelets, or may be formed in a liner or reinforced strip which is manufactured from a polymeric material such as polyurethane, and which is fixed to an outer perimeter of the sleeve.

The teeth are provided for retaining the upper portion 42 of the sleeve taut, and for retaining the shape and length of the free-hanging portion 40 of the sleeve relatively constant.

The sleeve is also driven by means of interaction between the teeth and the openings or slots of the sleeve.

The displacement mechanism 26 includes a drive unit, in the form of an electrical, hydraulic, or pneumatic motor 50, which, through the transmission 48, drives the rollers (36, 38). The transmission 48 also includes pulleys 52 on the motor 50 and the rollers (36, 38). The driving of the rollers (36, 38) therefore causes the sleeve to be rotated in use, which rotations cause a continuous displacement of the treatment surface 16, in a direction which is perpendicular to the travel or feed direction 20.

The apparatus comprises a main structure 54. The rollers (36, 38) are fixed to the main structure 54, through a substructure 56. The substructure 56 is pivotably fixed to the main structure 54, by means of a set of bearings 58. The motor 50 is also fitted to the substructure 56. The substructure 56 can pivot or rock relative to the main structure 54.

A rocking device 60 is fitted to the main structure 54 and provided for causing an operative rocking motion to the substructure 56. The relative displacement of the treatment surface 16 therefore has a component caused by the rocking of the substructure 56.

The rocking device 60 comprises a rocking motor 62 fitted to the main structure 54, the rocking motor 62 fitted with a crank member 64, and a set of rocking arms 66 connected between the crank member 64 and the substructure 56.

In some cases, the apparatus 10 may be fitted with a spray bar or header (not shown) which is provided for spraying water, during use, onto the flexible sheet 34, to remove or rinse portions of the floc sticking thereto. Water sprayed by the spray bar may be collected in the collection receptacle 28.

The displacement of the treatment surface 16, together with the influence of gravity, causes the slurry 18 to be displaced in the displacement or feed direction 20.

In some cases, which are not shown, the rollers may have a course spiraling outer surface, which creates folds in the sleeve. As the rollers rotate, the folds may induce a positive conveyor or peristaltic motion, which may cause the slurry 18 to be displaced in the travel or feed direction 20.

The apparatus 110 or 10 (as the case may be) may form part of a slurry treatment system, which further includes an upstream flocculant dosing and flocculating device (not shown). Such a system forms part of the present disclosure. The flocculant dosing and flocculating device typically takes the form of an in-line flocculating device, utilising a high molecular weight polyethylene oxide (POE) reagent, or a polyacrylamide reagent as dosing agent. The flocculant dosing and flocculating device includes a pipeline within which flocs can be generated under correct mixing and flow regimes, following which, flocculated slurry is supplied onto the treatment arrangement or surface, and the slurry is further treated as discussed above.

It will be appreciated that the above description only provides example embodiments of the invention and that there may be many variations without departing from the spirit and/or the scope of the invention. Also, features disclosed in respect of one example embodiment may be compatible with another example embodiment, unless stated otherwise or if the context dictates otherwise.

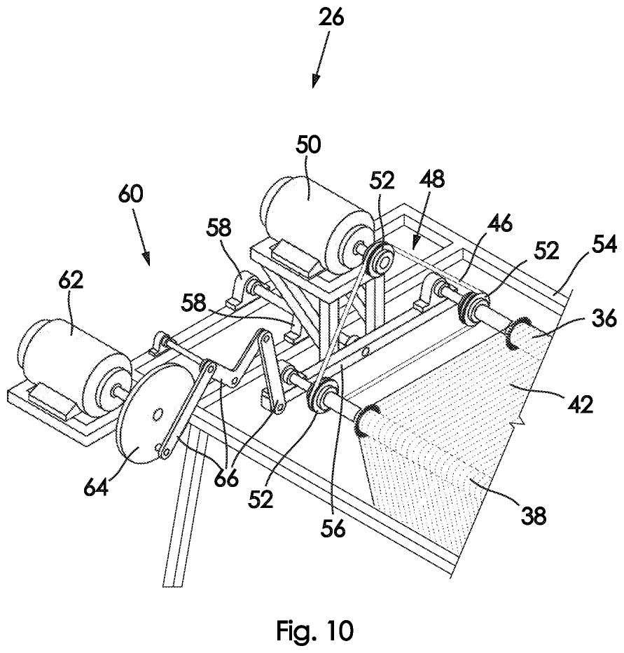

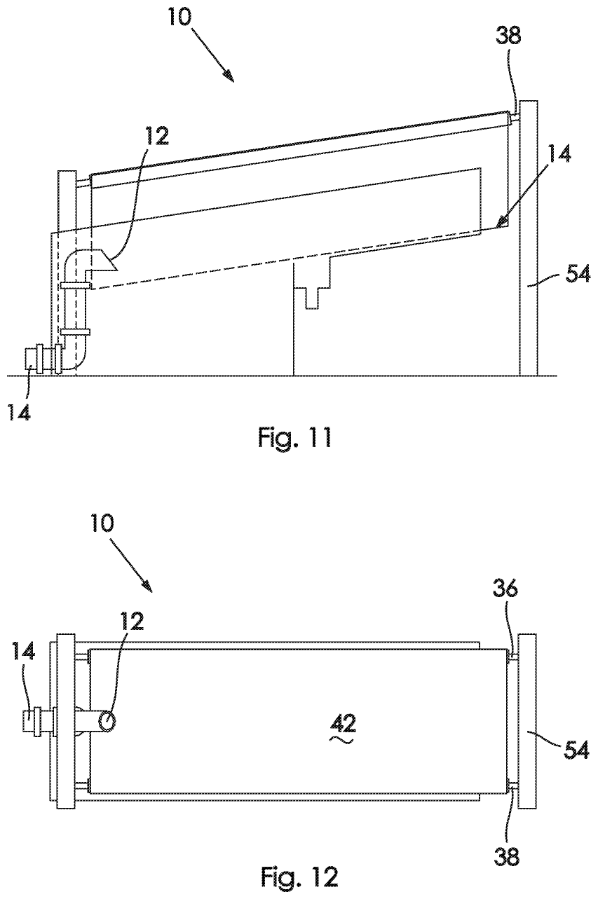

In the examples of FIGS. 9 and 10, the rollers (36, 38) are arranged substantially horizontally. However, in an alternative embodiment, such as shown in FIG. 11, the rollers (36, 38) are inclined slightly upwards, such that the charge opening 12 is lower than the discharge 22. In a further alternative embodiment (not shown), the rollers (36, 38) are inclined slightly downward (in the displacement direction), such that the charge opening 12 is higher than the discharge 22. In this way, gravity assists a positive flow or displacement of the slurry 18 relative to the treatment surface 16. It will be appreciated that the gravity-assisted displacement is still a gentle displacement. The gravity-assisted displacement further facilitates the “kneading”, “rolling” or “massaging” action imparted to the slurry.

Furthermore, in some cases of the apparatus 10, the two rollers (36, 38) converge towards the discharge 22, which causes a contact angle of the sleeve to become smaller in the travel or feed direction 20, and which may slightly increase a level of contact with the slurry in the travel or feed direction, to increase an amount of compaction effected by the treatment surface 16.

Furthermore, and as shown in FIG. 14, in some configurations, the displacement mechanism 26 may cause the rollers (36, 38) to oscillate, rather than rotate.

It is foreseen that some embodiments may include only a first roller 36.

In a further example, a dynamic slurry drive mechanism (not shown) may be provided for displacing the slurry in the travel feed direction 20. The slurry drive mechanism may take the form of a first course pitch auger which is rotated to drive the slurry in the travel feed direction 20. The slurry drive mechanism may also include a second course pitch auger. It will however be appreciated that the slurry drive mechanism has a very gentle interaction with the slurry, so as not to cause the flocs to break apart.

In yet another example, the apparatus may comprise a multi-stage apparatus, in which more than one treatment surfaces 16 are arranged in series along the travel or feed direction 20. The various treatment surfaces may have different configurations (such as different friction coefficients and different aperture sizes). Such different configurations may be based on an amount or degree of dewatering or compaction that has already taken place. Furthermore, the various treatment surfaces may be displaced at different speeds and/or intensities.

It is easily understood from the present application that the particular features of the present invention, as generally described and illustrated in the figures, can be arranged, and designed according to a wide variety of different configurations. In this way, the description of the present invention and the related figures are not provided to limit the scope of the invention but simply represent selected embodiments.

The skilled person will understand that the technical characteristics of a given embodiment can in fact be combined with characteristics of another embodiment, unless otherwise expressed or it is evident that these characteristics are incompatible. Also, the technical characteristics described in a given embodiment can be isolated from the other characteristics of this embodiment unless otherwise expressed.

1. An apparatus for treating a flocculated slurry with an initial liquid content, the apparatus comprising:
a treatment arrangement defining a treatment zone in which the slurry is supported on a treatment surface of the treatment arrangement;
a feed arrangement for feeding slurry into the apparatus;
a discharge through which output product is discharged from the treatment zone,
wherein the treatment surface is configured such that interaction between the treatment surface and the slurry causes at least a portion of liquid within the slurry to be separated therefrom, such that a liquid content of the output product is lower than the initial liquid content, wherein the treatment arrangement is formed by a flexible sheet.

2. The apparatus as claimed in claim 1 wherein the interaction between the treatment arrangement and the slurry, which causes at least a portion of liquid within the slurry to be separated therefrom, includes displacement and/or motion of the treatment surface relative to the slurry, including vibration and/or agitation, wherein the displacement and/or motion of the treatment surface relative to the slurry operatively causes a kneading or massaging action on the slurry, thereby mechanically squeezing liquid therefrom.

3. (canceled)

4. The apparatus as claimed in claim 1, wherein the treatment arrangement is arranged to receive the slurry on top thereof, in use, and is porous or foraminous to allow a portion of liquid to drain therethrough under gravity, wherein the apparatus further comprises a collection receptacle to collect liquid separated from the slurry, the collection receptacle being arranged below the treatment arrangement, the apparatus further comprising a conveyor arrangement for transporting the product discharged from the treatment arrangement through the discharge.

5. (canceled)

6. (canceled)

7. (canceled)

8. (canceled)

9. (canceled)

10. (canceled)

11. (canceled)

12. (canceled)

13. (canceled)

14. The apparatus as claimed in claim 1, wherein the apparatus includes a displacement arrangement mechanism comprising at least a first roller for operatively displacing the treatment arrangement relative to the slurry, wherein the flexible sheet is formed into a sleeve that is arranged around the first roller so as to be supported by or suspended from the first roller, wherein the treatment zone is formed by a first trough-shaped portion of the sleeve.

15. (canceled)

16. The apparatus as claimed in claim 14, wherein the displacement mechanism includes a second roller, wherein the sleeve is arranged around the second roller so as to be supported by or suspended from the second roller, wherein the first and second rollers are arranged substantially parallel to each other.

17. (canceled)

18. (canceled)

19. The apparatus as claimed in claim 16 wherein the displacement mechanism includes a drive unit, wherein the displacement mechanism further comprises a drive roller, driven by the drive unit, wherein the drive roller is arranged between the first and second rollers.

20. (canceled)

21. (canceled)

22. (canceled)

23. (canceled)

24. (canceled)

25. The apparatus as claimed in claim 16, wherein the apparatus includes a bottom roller supporting a bottom portion of the sleeve, such that first and second trough-shaped portions are formed towards opposite sides of the bottom roller, the first trough shaped-portion defining the treatment zone, and the second trough-shaped portion defining a feed zone, wherein the slurry is deposited onto the treatment arrangement, or sleeve, in the feed zone, from where the slurry is carried by the treatment arrangement, or sleeve, over the bottom roller towards the treatment zone.

26. (canceled)

27. The apparatus as claimed in claim 25, wherein the first and second trough-shaped portions are associated with tensioning arrangements to retain a shape of the trough-shaped portions and to keep the treatment apparatus taut in use, wherein the tensioning arrangements comprise contact shoes running on outer edges of the treatment arrangement, further wherein the feed arrangement is arranged within the second trough-shaped portion or feed zone.

28. (canceled)

29. (canceled)

30. The apparatus as claimed in claim 1, wherein the feed arrangement comprises:
a distribution header, comprising a plurality of outlets spaced along a width of the treatment arrangement, each outlet of the distribution header being associated with an outlet duct; and/or a feed container into which the plurality of outlets feed the slurry, and which is open at a top end to define an overflow, to allow slurry to spill over and onto the treatment arrangement, the feed container including a plurality of spaced compartments, each compartment being associated with, and fed by, a distinct outlet of the distribution header; and/or
a feed pan within which the feed container is arranged.

31. (canceled)

32. (canceled)

33. The apparatus as claimed in claim 30, wherein the distribution header is arranged above the feed container, and wherein the feed arrangement is designed in a manner that the outlet ducts feed slurry to a bottom of the respective compartments which allows the slurry within the respective compartment rises from the bottom towards the overflow in a controlled manner, at a controlled or predetermined rise rate.

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. The apparatus as claimed in claim 4, further including a scraper that is in contact with the treatment arrangement or sleeve, which is outside of and after the treatment zone, for aiding the removal of any material which may adhere to the treatment arrangement or sleeve, the apparatus further including a spray bar for rinsing an outer surface of the sleeve, whereas the water used in the process of rinsing the sleeve may be captured by the collection receptacle, the collection receptacle being arranged to drain into a return conduit, the apparatus further including a material displacement arrangement mounted in or proximate the treatment zone, to displace output product from the treatment zone and inhibit a buildup of material within the treatment zone.

46. (canceled)

47. (canceled)

48. (canceled)

49. The apparatus as claimed in claim 45 wherein the material displacement arrangement comprises a plough or scroll arrangement for urging output product towards one or both sides of the treatment zone where the output product is deposited from the treatment zone.

50. (canceled)

51. (canceled)

52. (canceled)

53. The apparatus as claimed in claim 1, further including a charge opening for depositing slurry onto the treatment arrangement, the slurry travelling in a travel or feed direction, wherein the rollers are arranged at an incline upwards, in the displacement direction, such that the charge opening is lower than the discharge or wherein the rollers are arranged at an incline downwards, in the displacement direction, such that the charge opening is higher than the discharge, for facilitating gravity-assisted displacement of the slurry relative to the treatment surface.

54. (canceled)

55. (canceled)

56. (canceled)

57. (canceled)

58. (canceled)

59. (canceled)

60. (canceled)

61. (canceled)

62. The apparatus as claimed in claim 16, wherein the apparatus comprises a main structure, with the first and second rollers being mounted to a subframe, which in turn, is pivotably mounted to the main structure, the apparatus further including a rocking device for causing a rocking motion of the subframe, the rocking device, when in use, causes further displacement of the treatment surface.

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. A system for treating a slurry, comprising:
a flocculent dosing and flocculating device; and
apparatus for treating a flocculated slurry with an initial liquid content, the apparatus comprising:
a treatment arrangement defining a treatment zone in which the slurry is supported on a treatment surface of the treatment arrangement;
a feed arrangement for feeding slurry into the apparatus;
a discharge through which output product is discharged from the treatment zone, wherein the treatment surface is configured such that interaction between the treatment surface and the slurry causes at least a portion of liquid within the slurry to be separated therefrom, such that a liquid content of the output product is lower than the initial liquid content, wherein the treatment arrangement is formed by a flexible sheet,
wherein the flocculant dosing and flocculating device receives a feed of slurry, the feed of slurry being flocculated by dosing the slurry and allowing flocs to be generated, the flocculated slurry being provided via the feed arrangement of the apparatus to the treatment arrangement of the apparatus.

78. The system as claimed in claim 77, wherein the flocculant dosing and flocculant device comprises an in-line flocculant dosing and flocculating device, wherein the flocculant dosing and flocculating device utilizes a higher molecular weight polyethylene oxide flocculating reagent or a polyacrylamide reagent to flocculate the slurry.

79. (canceled)

80. A method for treating a flocculated slurry with an initial liquid content, the method comprising the steps of:
1. providing an apparatus for treating a flocculated slurry with an initial liquid content;
2. feeding the slurry through a feed arrangement onto a treatment arrangement of the apparatus;
3. causing the slurry to be displaced relative to the treatment arrangement;
4. separating at least a portion of liquid from the slurry as it is displaced relative to the treatment arrangement; and
5. discharging an output product through a discharge of the apparatus, which output product has a liquid content which is lower than the initial liquid content, wherein step 2 is preceded by the following steps:
2a) receiving a feed of slurry from a supply;
2b) utilising a flocculant dosing and flocculating device to flocculate the slurry; and
2c) feeding the flocculated slurry to the charge opening.
wherein step 2b) includes adding a high molecular weight polyethylene oxide flocculating reagent to the slurry to flocculate the slurry.

81. (canceled)

82. (canceled)

83. The method as claimed in claim 80 wherein step 4 comprises displacing the treatment arrangement relative to the slurry to cause the water to separate from the slurry and to cause the floc aggregates to become dewatered, densified and compacted.

84. The method as claimed in claim 83 wherein the displacement of the treatment arrangement causes the floc aggregates to roll over itself and become kneaded mechanically under the influence of gravity.
